(19) United States
(12) Patent Application Publication
(10) Pub. No.: US 2013/0037394 A1
(43) Pub. Date: Feb. 14, 2013

(54) Constant Force Adapter for Remotely Racking Circuit Breakers and Contactors.

(71) Applicants: Chester Levi Greer, Baton Rouge, LA (US); Billy W. Lively, Zachary, LA (US)

(72) Inventors: Chester Levi Greer, Baton Rouge, LA (US); Billy W. Lively, Zachary, LA (US)

(73) Assignee: INOLECT, LLC, Baton Rouge, LA (US)

(21) Appl. No.: 13/207,916

(22) Filed: Aug. 11, 2011

(51) Int. Cl. H02B 11/02

(52) U.S. Cl. 200/50.24

(57) ABSTRACT

An apparatus and system are provided for remotely racking circuit breakers and contactors that are housed within a housing structure, such as a circuit breaker cell or switchgear cabinet. The apparatus and system are capable of maintaining a constant force on breakers during racking operations.

### CROSS-REFERENCE TO RELATED APPLICATION

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The present disclosure relates to subject matter for remotely racking a circuit breaker, particularly subject matter including a force amplifying or levering mechanism for locking the breaker in each of its plurality of positions automatically without the need for operator intervention to determine how far the circuit breaker must be displaced to place it in the desired position.

2. Description of Related Art

In utility and industrial applications, circuit breakers and contractors are utilized to establish electrical circuits. From time to time, maintenance requirements (e.g. repair, replacement, or load control) necessitate racking operations to disconnect (“rack out”) and connect (“rack in”) these breakers or contactors. During these operations, electrical circuits may short-circuit and produce a dangerous condition known as an arc flash.

Arc-flash occurs when an electric current passes through air when insulation or isolation between electrified conductors is insufficient to withstand the applied voltage. During an arc flash, temperatures rapidly escalate causing conductors to melt, vaporize, and expand to several thousand times their normal volume, which generates a pressure wave carrying molten metal capable of hitting surfaces with forces of several hundred pounds per square inch. As a result, maintenance personnel must possess a means and method for safely performing racking operations to prevent injury or death from an arc-flash.

In the past, maintenance personnel have utilized personal protective equipment (PPE) to reduce exposure to potential arc flash hazards. However, PPE alone will not eliminate the risk of injury or death because personnel are still in close proximity to the circuit breaker during racking operations. In order to mitigate the likelihood of injury or death further, personnel must perform racking operations a safe distance from the circuit breaker, i.e. remotely.

Racking operations on a breaker commonly occur by horizontally moving the circuit breaker within its cabinet or cell housing using an elongated shaft that is coupled to the circuit breaker. As the shaft rotates, the circuit breaker moves horizontally within its cabinet until it is either disconnected (“racked out”) or connected (“racked in”) from its power terminals.

U.S. Pat. No. 6,897,388 discloses an apparatus and method for remotely moving a circuit breaker into or from circuit breaker cell housing. However, this apparatus and method is not adapted to maintain a smooth and steady force during racking operations on breakers that move more than approximately three inches. Thus, a need exists for more versatile apparatus capable of maintaining a smooth and steady force during racking operations on breakers that move approximately three inches or more.

### BRIEF SUMMARY OF THE INVENTION

The object of this invention is to provide a more versatile apparatus and method for remotely racking circuit breakers and contactors, particularly circuit breakers and contactors that move approximately three inches or more during racking operations.

For purposes of illustration, the invention will be described as applied to medium voltage circuit breakers. However, the invention may also be applied to other types of electrical apparatus (e.g., without limitation, circuit switching devices and other circuit interrupters such as contactors, motor starters, motor controllers and other load controllers) housed within a housing structure, such as a circuit breaker cell or switchgear cabinet.

This invention is a constant force adapter. The constant force adapter comprises a drive tube with at least one constant tension spring (preferably two constant tension springs), an inner race, and an outer race. The drive tube is hollow enclosure provided with a head and a drive. The head serves as an end cap for the drive tube that couples the drive to the head. The drive is a coupling, such as a female socket connection, designed to couple the constant force adapter to the adapter structure of a remote racking unit.

The drive tube is coupled to a housing tube drive. The housing tube drive contains the constant tension springs and the outer race. The constant tension springs and the outer race are maintained in position by a cartridge.

The inner race is force transmitting member, preferably a spline. The outer race is preferably a ball housing. The inner race is provided with a coupling and a drive at one end to facilitate a connection with a circuit breaker. The drive is a coupling, such as a male socket connection, designed to couple to the circuit breaker connection. The opposite end of the inner race is coupled to the constant tension springs by a coupling, such as a collar.

The constant tension springs are mounted on bearings to reduce wear and to facilitate extended use. The bearings are mounted with a coupling, such as a screw. The minimum amount of force the constant tension springs must supply is dependent upon the amount of force necessary to “rack in” or “rack out” a circuit breaker.

The length of the inner race and drive tube is largely dependent on the distance the breaker must travel during racking operations. Typical travel distances for medium voltage breakers range from approximately three inches to fourteen inches or more. The length of the inner race is at least the distance the breaker must travel during racking operations, preferably at least the distance the breaker must travel during racking operations plus an appropriate design margin. The length of the drive tube is preferably at least the distance the breaker must travel during racking operations.

The constant force adapter as described above in conjunction with a remote racking unit is capable of maintaining a smooth and steady force during racking operations. As the remote racking unit motor rotates the shaft, the constant force adapter also rotates and the inner race either extends or retracts depending on the racking operation. The linear motion adapter drive may be used with virtually any remote racking unit with an adapter structure.

### BRIEF DESCRIPTION OF THE SEVERAL VIEWS OF THE DRAWING(S)

FIG. 1 is a side view of a remote racking apparatus.

FIG. 2 is a side view of the constant force adapter in the partially compressed position.

FIG. 3 is a side view of the constant force adapter in the extended position.

### DETAILED DESCRIPTION OF THE INVENTION

For purposes of illustration, the invention will be described as applied to medium voltage circuit breakers. However, the invention may also be applied to other types of electrical apparatus (e.g., without limitation, circuit switching devices and other circuit interrupters such as contactors, motor starters, motor controllers and other load controllers) housed within a housing structure, such as a circuit breaker cell or switchgear cabinet.

Directional phrases used herein relate to the orientation of the elements shown in the drawings and are not limiting upon the claims unless expressly recited therein. For example, left, right, top, bottom, clockwise, counterclockwise and derivatives thereof.

As employed herein, the term “fastener” refers to any suitable connecting, coupling, or tightening mechanism expressly including, but not limited to, screws, bolts, pins, and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

As employed herein, the term “racking” refers to any suitable manipulation of an electrical apparatus, such as a circuit breaker, with respect to a housing structure (e.g., without limitation, switchgear cabinet) and expressly includes, without limitation, insertion or removal of the circuit breaker from the switchgear cabinet.

As employed herein, the term “link” refers to any known or suitable mechanism (e.g., without limitation, a cable; a wire; a chain; a number of interconnected links; a rigid member such as a socket extension) for interconnecting one component to another in order to provide mechanical communication there between.

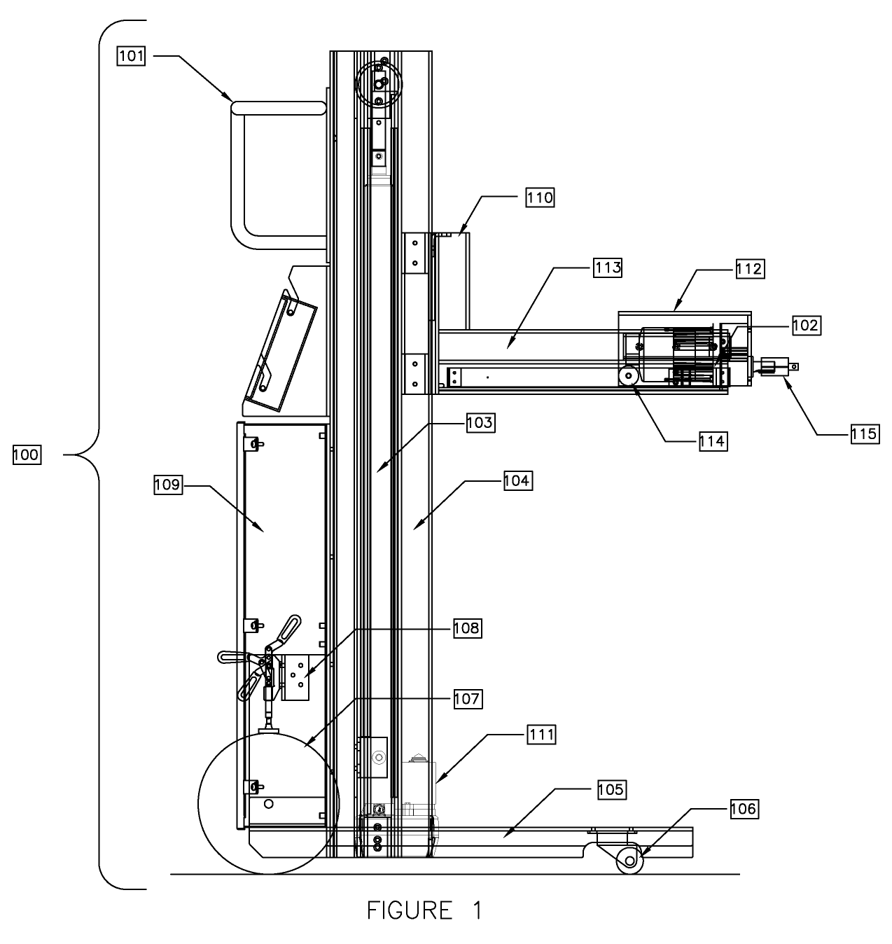

A remote racking unit used in accordance with this invention is shown generally in FIG. 1 at 100. The remote racking unit 100 comprises a stationary vertical support 103 fixed to a racking unit base 105. The stationary vertical support 103 and racking unit base 105 remain stationary and are in a fixed position at all times.

The racking unit base 105 is equipped with at least one front wheel 106 and at least one rear wheel 107. The front wheel 106 is preferably a caster type wheel that enables turning of the remote racking unit 100. The rear wheel 107 is preferably a flat free style wheel that is larger than the front wheel 106 and allows an operator to easily move the remote racking unit 100. Both the front 106 and rear wheel 107 are coupled to the racking unit base 105.

The remote racking unit also has an intermediate structural support 104, which is engaged in a low friction substantially vertical sliding relationship with the stationary vertical support 103. The intermediate structural support 104 moves vertically with respect to the stationary vertical support 103, but it is not directly connected to the stationary vertical support 103. The stationary structural support 103 provides a guiding means for guiding and moving the intermediate structural support 104 along the vertical axis.

An actuator is coupled to the bottom of the stationary vertical support 103 and to the top of the intermediate structural support 104. An actuator 111 is utilized to move the intermediate structural support 104 along the vertical axis. As the actuator 111 extends, the intermediate structural support 104 moves upwardly as well. As the actuator 111 retracts, the intermediate structural support 104 moves downwardly.

The remote racking unit is also provided with a motor mount structure 113 having a sliding motor structure 110. The motor mount structure 113 provides a means to support a motor 102 and also allows the motor 102 to slide forward and backward along the horizontal axis. Not shown is a link that is connected to the top portion of the stationary vertical support 103 and passes over the top of the intermediate structural support 104 and then extends downward and attaches to the sliding motor structure 110. As the intermediate structural support 104 extends upward, the link is pulled over the top of the intermediate structural support 104 resulting in the vertical movement of the sliding motor structure 110 at a 2:1 ratio, i.e. for every inch that the intermediate structural support 104 moves vertically, the sliding motor structure 110 moves vertically by a multiple of 2.

The sliding between supports is accomplished by placing wear resistant slippery nylon (not shown) in the area between the supports to eliminate contact friction. The nylon is located at the top of the stationary structural support 103, the top of the intermediate structural support 104, and along the entire length of the sliding motor structure 110. The stationary structural support 103, intermediate structural support 104, sliding motor structure 110, and motor mount structure 113 are all made of extruded aluminum that is anodized for premier performance, quality, and corrosion resistance with a limited coefficient of friction.

The motor 102 is supported by the motor mount structure 113. The motor 102 is preferably a three phase racking motor. The motor is also provided with a shaft and adapter structure 115. The adapter structure is fabricated and arranged to be coupled with a horizontally configured circuit breaker.

Alternatively, the adapter structure 115 may be coupled to an adapter, such as a constant force adapter 200.

The remote racking unit has a control box 109 that houses the electronic controls of the unit. The electronic controls comprise a variable frequency drive and a controller, such as a programmable logic controller (PLC); however, the electronic controls are not limited to these items. The control box 109 is attached to the racking unit base 105 and to the vertical member 103. The variable frequency drive and programmable logic controller in the control box 109 control the motor 102. The motor 102 may slide back and forth with the breaker along the motor mount structure 113. A motor housing 112 houses the motor 102. The motor housing 112 provides shielding for motor 102. The motor housing 112 is maintained in the forward position by the constant force springs 114, which allows the motor 102 to be in constant engagement with the breaker or adapter it is operating.

In addition, the remote racking unit 100 may also have a brake assembly 108 that allows an operator to maintain the remote racking unit 100 in position during racking operations. The brake assembly 108 is attached to the racking unit base 105 and interacts with the rear wheel 107. An encoder is mounted to the motor 102. The encoder mounted to the motor 102 and the constant force springs 114 mounted on the horizontal motor carriage 113 track both circuit breaker and racking unit movement and position.

The remote racking unit 100 is controlled from a control station (not shown), preferably a touch screen device. In one embodiment of the invention, the control station is connected to the device control box 109 by a 75 Ft communications/control cable. In another embodiment of the invention, the control station wirelessly communicates with the device control box 109. The remote racking unit 100 utilizes standard 120 Volt A.C. power, and does not require any interconnection with circuit breaker or switchgear wiring or controls.

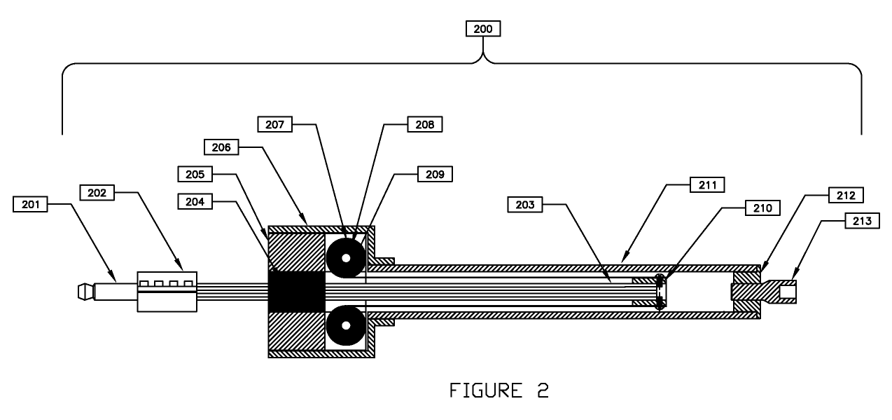

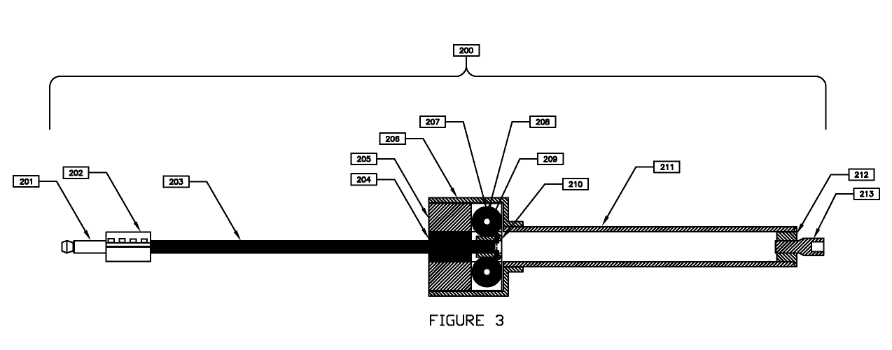

A constant force adapter in accordance with the present invention is shown generally in FIG. 2 at 200 and FIG. 3 at 200. FIG. 2 depicts the constant force adapter in a partially compressed position, whereas FIG. 3 depicts the constant force adapter in an extended position.

The constant force adapter 200 comprises a drive tube 211 with at least one constant tension spring 207 (preferably two constant tension springs), an inner race 203, and an outer race 204. The drive tube 211 is hollow enclosure provided with a head 212 and a drive 213. The head 212 serves as an end cap for the drive tube 211 that couples the drive to the head 212. The drive 213 is a coupling, such as a female socket connection, designed to couple the constant force adapter 200 to the adapter structure 115 of a remote racking unit.

The drive tube 211 is coupled to a housing tube drive 206. The housing tube drive 206 contains the constant tension springs 207 and the outer race 204. The constant tension springs 207 and the outer race 204 are maintained in position by a cartridge 205.

The inner race 203 is force transmitting member, preferably a spline. The outer race 204 is preferably a ball housing. The inner race 203 is provided with a coupling 202 and a drive 201 at one end to facilitate a connection with a circuit breaker. The drive 201 is a coupling, such as a male socket connection, designed to couple to the circuit breaker connection. The opposite end of the inner race is coupled to the constant tension springs 207 by a coupling 210, such as a collar.

The constant tension springs 207 are mounted on bearings 208 to reduce wear and to facilitate extended use. The bearings 208 are mounted with a coupling 209, such as a screw. The minimum amount of force the constant tension springs 207 must supply is dependent upon the amount of force necessary to “rack in” or “rack out” a circuit breaker.

The length of the inner race 203 and drive tube 211 is largely dependent on the distance the breaker must travel during racking operations. Typical travel distances for medium voltage breakers range from approximately three inches to fourteen inches or more. The length of the inner race 203 is at least the distance the breaker must travel during racking operations, preferably at least the distance the breaker must travel during racking operations plus an appropriate design margin. The length of the drive tube 211 is preferably at least the distance the breaker must travel during racking operations.

The constant force adapter as described above in conjunction with a remote racking unit is capable of maintaining a smooth and steady force during racking operations. As the remote racking unit motor rotates the shaft, the constant force adapter also rotates and the inner race either extends or retracts depending on the racking operation. When a circuit breaker is “racked in”, the inner race 203 begins in a compressed position as shown in FIG. 2. As the breaker is “racked in”, the inner race 203 extends from the drive tube 211 as shown in FIG. 3. When a circuit breaker is “racked out”, the inner race 203 begins in an extended position as shown in FIG. 3. As the breaker is “racked out”, the inner race 203 contracts or compresses into the drive tube 211 as shown in FIG. 2.

Although the linear motion adapter 200 is described in relation to the remote racking unit 100 shown in FIG. 1, the constant force adapter is not limited to this embodiment of the remote racking unit. The drive 213 may be modified by one of ordinary skill in the art to fit virtually any remote racking unit with an adapter structure.

Any reference to patents, documents and other writings contained herein shall not be construed as an admission as to their status with respect to being or not being prior art. It is understood that the array of features and embodiments taught herein may be combined and rearranged in a large number of additional combinations not directly disclosed, as will be apparent to one having skill in the art.

There are, of course, other alternate embodiments, which are obvious from the foregoing descriptions of the invention, which are intended to be included within the scope of the invention, as defined by the following claims.

What is claimed is:

1. A constant force adapter coupled to a remote racking apparatus having an adapter structure for remotely connecting and disconnecting a circuit breaker or contactor from a cell housing, the constant force adapter comprising:
a. a drive tube;
b. at least one spring;
c. an inner race;
d. an outer race;

2. The linear motion adapter of claim 1, wherein said spring is a constant tension spring.

3. The linear motion adapter of claim 2, wherein said drive tube further comprises a head and a drive.

4. The linear motion adapter of claim 3, wherein said drive tube is a hollow enclosures coupled to a housing tube drive.

5. The linear motion adapter of claim 4, wherein said housing drive tube contains the constant tension spring and the outer race.

6. The linear motion adapter of claim 5, wherein said constant tension spring and outer race are maintained in position by a cartridge.

7. The linear motion adapter of claim 6, wherein said inner race is provided with a coupling and a drive at one end to facilitate a connection with a circuit breaker.

8. The linear motion adapter of claim 7, wherein said inner race is a spline.

9. The linear motion adapter of claim 8, wherein said inner race is coupled to the constant tension spring by a coupling.

10. The linear motion adapter of claim 9, wherein said outer race is a ball housing.
